(19) United States
(12) Patent Application Publication
(10) Pub. No.: US 2026/0140728 A1
(43) Pub. Date: May 21, 2026

(54) DATA PROCESSING METHOD, APPARATUS AND DEVICE

(71) Applicants: China Mobile Communication Co., Ltd Research Institute, Beijing (CN); China Mobile Communications Group Co., Ltd., Beijing (CN)

(72) Inventors: Lingli DENG, Beijing (CN); Yuhan ZHANG, Beijing (CN); Kai LU, Beijing (CN); Yan YANG, Beijing (CN); Di JIN, Beijing (CN)

(21) Appl. No.: 19/120,971

(22) PCT Filed: Nov. 23, 2023
(86) PCT No.: PCT/CN2023/133656

§ 371 Date: Apr. 14, 2025

(30) Foreign Application Priority Data
Nov. 23, 2022 (CN) 202211472249.3

(51) Int. Cl. G06F 8/61; G06N 20/00

(52) U.S. Cl. CPC G06F 8/61; G06N 20/00

(57) ABSTRACT

A data processing method, apparatus and device are provided. The data processing method includes: obtaining application requirement information according to function requirement information and preset template information; performing resource exploration according to the application requirement information; when a result of the resource exploration indicates that a target application is allowed to operate, according to the application requirement information, allocating, from target operation platform resource, application resource to the target application, and creating an operation environment for the target application; deploying and releasing the target application according to the application resource and the operation environment; wherein the target application is an application program corresponding to the application requirement information.

### CROSS-REFERENCE TO RELATED APPLICATION

The present application claims a priority to the Chinese patent application No. 202211472249.3 filed in China on Nov. 23, 2022, a disclosure of which is incorporated herein by reference in its entirety.

### TECHNICAL FIELD

The present disclosure relates to the field of information processing technology, and in particular, to a data processing method, apparatus and device.

### BACKGROUND

A known artificial intelligence (AI) capability platform integrates AI capabilities and provides cloud services for core artificial intelligence capabilities. There are two sources of service deployment on the AI capability platform. One is an existing service of the capability store in the capability platform (such as text classification, facial recognition, scene recognition, etc.); the other is that a capability provider can use a private image, upload the image, and then configure relevant parameters, and deploy and release it as a service. According to an image uploaded to the AI capability platform and a configuration of related environment resource, the capability platform allocates relevant resources, installs and deploys a service, and makes a capability service available.

Specifically, in the AI capability platform, the capability provider focuses on training models and combining models, and providing an intelligent core capability service, and only provides open capabilities as part of an intelligent application; when developing the intelligent application, the capability user first needs to call the existing service on the AI capability platform, and then configure the environment, interface and other parameters according to the application operation environment, package them into an installation package, and then deploy and release the intelligent application on an application platform.

Thus, the current technical solutions can realize flexible deployment and release of the capability service. However, for a network intelligent application in a self-intelligent network that needs to achieve large-scale deployment and refined operations, after the relevant capabilities are released, real-time paths need to be established with the managed network environment in both data uplink and inference downlink. Furthermore, continuous monitoring of its operational performance is necessary, along with online iterative optimization support. Currently, these operations are primarily performed manually, which leads to defects such as time consumption, poor flexibility, and low accuracy. Therefore, more flexible configuration is required for the parameters and workflows required for capability deployment.

Consequently, the information processing solutions for the application deployment and release in the related art face issues such as high labor costs, low efficiency and low accuracy.

### SUMMARY

An object of the present disclosure is to provide a data processing method, apparatus and device to, solve the problems of high labor cost, low efficiency and low accuracy of information processing solutions for the application deployment and release in related art.

To solve the above technical problems, the present disclosure provides a data processing method, including:
obtaining application requirement information according to function requirement information and preset template information;
performing resource exploration according to the application requirement information;
when a result of the resource exploration indicates that a target application is allowed to operate, according to the application requirement information, allocating, from target operating platform resource, application resource to the target application, and creating an operation environment for the target application;
deploying and releasing the target application according to the application resource and the operation environment;
wherein the target application is an application program corresponding to the application requirement information.

Optionally, the preset template information includes at least one of the followings: environment requirement information;
interface configuration information;
application algorithm information; or
application procedure information.

Optionally, the performing the resource exploration according to the application requirement information includes:
exploring whether target release environment resource and/or the target operating platform resource meet deployment and release requirements of the target application according to the application requirement information.

Optionally, the deploying and releasing the target application further includes:
obtaining a trained application algorithm model according to application algorithm information in the application requirement information; or
obtaining offline training data according to the application algorithm information in the application requirement information; and performing online training according to the offline training data, to obtain the application algorithm model; or
obtaining first online training data according to the application algorithm information in the application requirement information; and performing online training according to the first online training data to obtain the application algorithm model;
the deploying and releasing the target application according to the application resource and operation environment includes:
deploying and releasing the target application according to the application resource, the operation environment and the application algorithm model.

Optionally, the application algorithm information includes: data annotation script information;
the obtaining the first online training data according to the application algorithm information in the application requirement information includes:
online collecting data annotation of data according to the data annotation script information, and generating the first online training data.

Optionally, the application algorithm information includes an incentive feedback function;
after deploying and releasing the target application according to the application resource, the operation environment and the application algorithm model, the method further includes:
online updating the application algorithm model in the target application according to second online training data and the incentive feedback function.

Optionally, after deploying and releasing the target application, the method further includes:
obtaining input data by using the target application, and analyzing the input data to obtain an application analysis result.

Optionally, the obtaining the input data by using the target application includes:
obtaining offline input data by using the target application, or obtaining online input data from a network management system;
after obtaining the application analysis result, the method further includes:
sending the application analysis result to the network management system.

The embodiments of the present application further provide a data processing apparatus, including:
a first processing module, configured to obtain application requirement information according to function requirement information and preset template information;
a second processing module, configured to perform resource exploration according to the application requirement information;
a third processing module, configured to, when a result of the resource exploration indicates that a target application is allowed to operate, according to the application requirement information, allocate, from target operating platform resource, application resource to the target application, and create an operation environment for the target application;
a fourth processing module, configured to deploy and release the target application according to the application resource and operation environment;
wherein the target application is an application program corresponding to the application requirement information.

Optionally, the preset template information includes at least one of the followings:
environment requirement information;
interface configuration information;
application algorithm information; or
application procedure information.

Optionally, the performing the resource exploration according to the application requirement information includes:
exploring whether target release environment resource and/or the target operating platform resource meet deployment and release requirements of the target application according to the application requirement information.

Optionally, the deploying and releasing the target application further includes:
obtaining a trained application algorithm model according to application algorithm information in the application requirement information; or
obtaining offline training data according to the application algorithm information in the application requirement information; and performing online training according to the offline training data, to obtain the application algorithm model; or
obtaining first online training data according to the application algorithm information in the application requirement information; and performing online training according to the first online training data to obtain the application algorithm model;
the deploying and releasing the target application according to the application resource and operation environment includes:
deploying and releasing the target application according to the application resource, the operation environment and the application algorithm model.

Optionally, the application algorithm information includes: data annotation script information;
the obtaining the first online training data according to the application algorithm information in the application requirement information includes:
online collecting data annotation of data according to the data annotation script information, and generating the first online training data.

Optionally, the application algorithm information includes an incentive feedback function;
the data processing apparatus further includes:
the first updating module, configured to, after deploying and releasing the target application according to the application resource, the operation environment and the application algorithm model, online update the application algorithm model in the target application online according to second online training data and the incentive feedback function.

Optionally, the apparatus further includes:
a fifth processing module, configured to, after deploying and releasing the target application, obtain input data by using the target application, and analyze the input data to obtain an application analysis result.

Optionally, the obtaining the input data by using the target application includes:
obtaining offline input data by using the target application, or obtaining online input data from a network management system;
the data processing apparatus further includes:
a first sending module, configured to send the application analysis result to the network management system after obtaining the application analysis result.

The embodiments of the present disclosure further provide a data processing device, including: a processor;
the processor is configured to obtain application requirement information according to function requirement information and preset template information;
perform resource exploration according to the application requirement information;
when a result of the resource exploration indicates that a target application is allowed to operate, according to the application requirement information, allocate, from target operating platform resource, application resource to the target application, and create an operation environment for the target application;
deploy and release the target application according to the application resource and operation environment;
wherein the target application is an application program corresponding to the application requirement information.

Optionally, the preset template information includes at least one of the followings:
environment requirement information;
interface configuration information;
application algorithm information; or
application procedure information.

Optionally, the performing the resource exploration according to the application requirement information includes:
exploring whether target release environment resource and/or the target operating platform resource meet deployment and release requirements of the target application according to the application requirement information.

Optionally, the deploying and releasing the target application further includes:
obtaining a trained application algorithm model according to application algorithm information in the application requirement information; or
obtaining offline training data according to the application algorithm information in the application requirement information; and performing online training according to the offline training data, to obtain the application algorithm model; or
obtaining first online training data according to the application algorithm information in the application requirement information; and performing online training according to the first online training data to obtain the application algorithm model;
the deploying and releasing the target application according to the application resource and operation environment includes:
deploying and releasing the target application according to the application resource, the operation environment and the application algorithm model.

Optionally, the application algorithm information includes: data annotation script information;
the obtaining the first online training data according to the application algorithm information in the application requirement information includes:
online collecting data annotation of data according to the data annotation script information, and generating the first online training data.

Optionally, the application algorithm information includes an incentive feedback function;
the processor is further configured to,
after deploying and releasing the target application according to the application resource, the operation environment and the application algorithm model, online update the application algorithm model in the target application according to second online training data and the incentive feedback function.

Optionally, the processor is further configured to,
after deploying and releasing the target application, obtain input data by using the target application, and analyze the input data to obtain an application analysis result.

Optionally, the obtaining the input data by using the target application includes:
obtaining offline input data by using the target application, or obtaining online input data from a network management system via a transceiver;
the processor is further configured to,
after obtaining the application analysis result, send the application analysis result to the network management system via a transceiver.

The embodiments of the present disclosure further provide a data processing device, including a memory, a processor, and a program stored in the memory and executable on the processor; wherein the processor is configured to execute the program to implement the data processing method.

The embodiments of the present disclosure further provide a readable storage medium storing a program, wherein the program is used to be executed by a processor to implement the steps in the data processing method.

The beneficial effects of the technical solution of the present disclosure are as follows:
in the above solutions, according to the data processing method, it obtains application requirement information according to function requirement information and preset template information; performs resource exploration according to the application requirement information; and deploys and releases the target application when a result of the resource exploration indicates that the target application is allowed to operate; wherein the target application is an application program corresponding to the application requirement information. This achieves the goal of automatically deploying and releasing an application according to the requirement, improves processing efficiency and accuracy, reduces manual operations, and reduces labor costs. It effectively solves the problems of high labor cost, low efficiency, and low accuracy of information processing solutions for the application deployment and release in related art.

### BRIEF DESCRIPTION OF THE DRAWINGS

FIG. 1 is a schematic diagram of a flow chart of a data processing method according to the embodiments of the present application;

FIG. 2 is a schematic diagram of an implementation framework of a data processing method according to the embodiments of the present application;

FIG. 3 is a schematic diagram of a specific implementation framework of the data processing method according to the embodiments of the present application;

FIG. 4 is another schematic diagram of the specific implementation framework of the data processing method according to the embodiments of the present application;

FIG. 5 is yet another schematic diagram of the specific implementation framework of the data processing method according to the embodiments of the present application;

FIG. 6 is still yet another schematic diagram of the specific implementation framework of the data processing method according to the embodiments of the present application;

FIG. 7 is a structural diagram of a data processing apparatus according to the embodiments of the present application;

FIG. 8 is a structural diagram of a data processing device according to the embodiments of the present application.

### DETAILED DESCRIPTION

In order to make the technical problems, technical solutions and advantages to be solved of the present disclosure clearer, a detailed description will be given below with reference to the accompanying drawings and specific embodiments.

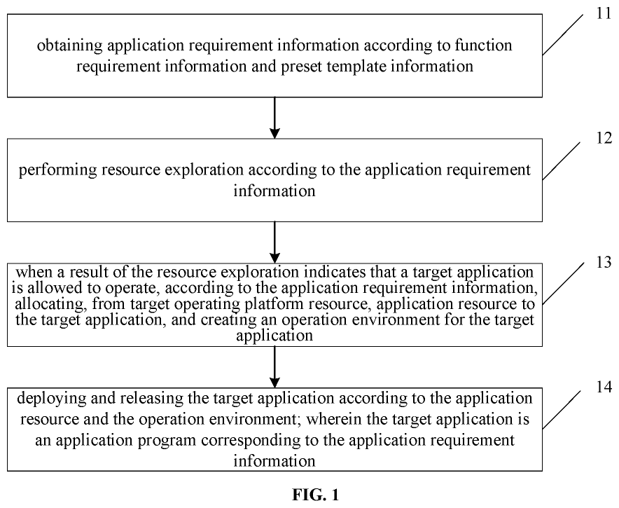

The present disclosure aims to solve the problems of high labor cost, low efficiency and low accuracy of information processing solutions for the application deployment and release in related art, and provides a data processing method, as shown in FIG. 1, including:
step 11: obtaining application requirement information according to function requirement information and preset template information;
step 12: performing resource exploration according to the application requirement information;
step 13: when a result of the resource exploration indicates that a target application is allowed to operate, according to the application requirement information, allocating, from target operation platform resource, application resource to the target application, and creating an operation environment for the target application;
step 14: deploying and releasing the target application according to the application resource and operation environment; wherein the target application is an application program corresponding to the application requirement information.

The function requirement information can be determined according to the instruction inputted by the user. Regarding “obtaining application requirement information according to function requirement information and preset template information”, it can be understood as: the user selects a template parameter in a template according to the requirement and adds a specific parameter value to obtain the application requirement information, but the present disclosure is not limited thereto.

In the data processing method provided by the embodiments of the present disclosure, it obtains application requirement information according to function requirement information and preset template information; performs resource exploration according to the application requirement information; and deploys and releases the target application when a result of the resource exploration indicates that the target application is allowed to operate; wherein the target application is an application program corresponding to the application requirement information. Accordingly, it may achieve the goal of automatically deploying and releasing an application according to the requirement, improve processing efficiency and accuracy, reduce manual operations, and reduce labor costs. It effectively solves the problems of high labor cost, low efficiency, and low accuracy of information processing solutions for the application deployment and release in related art.

The preset template information includes at least one of the followings: environment requirement information; interface configuration information; application algorithm information; or application procedure information.

As a result, it can provide as much template information as possible required for application deployment and release.

In the embodiments of the present disclosure, the performing resource exploration according to the application requirement information includes: exploring whether target release environment resource and/or the target operation platform resource meet deployment and release requirements of the target application according to the application requirement information.

That is, based on the application requirement information, it is possible to explore whether the target release environment resource meets the deployment and release requirements of the target application, or to explore whether the target operation platform resource meets the deployment and release requirements of the target application, or alternatively, to explore whether both the target release environment resource and the target operation platform resource meet the deployment and release requirements of the target application.

The exploring whether the target operation platform resource meets deployment and release requirements of the target application can refer to explore whether an interface configuration of an application service logic such as exploration data collection and inference instruction issuance meets the deployment and release requirements of the target application;

The requirement of the exploring the target operation platform resource may refer to whether the resource configuration of the application operation container of the virtual machine/container operation (CPU, memory, network, algorithm framework, etc.) meets the deployment and release requirements of the target application.

In this way, resource exploration can be performed accurately. In this solution, when it is (i.e., when the target release environment resource and/or target operation platform resource meet the deployment and release requirements of the target application), the result of the resource exploration is determined to indicate that the target application is allowed to operate; and/or, the “creating an operation environment for the target application” includes: allocating, from the target release environment resource, environment resource to the target application. In this solution, application resource (i.e. operation resource) and environment resource need to be allocated to the target application.

The deployment and release of the target application further includes: obtaining a trained application algorithm model according to application algorithm information in the application requirement information; or, obtaining offline training data according to the application algorithm information in the application requirement information; and performing online training according to the offline training data to obtain the application algorithm model; or, obtaining first online training data according to the application algorithm information in the application requirement information; and performing online training according to the first online training data to obtain the application algorithm model; the deploying and releasing of the target application according to the application resource and operation environment includes: deploying and releasing the target application according to the application resource, operation environment and application algorithm model.

It allows for diversified acquisition of the algorithm model and supports deployment and release of the application.

In the embodiments of the present disclosure, the application algorithm information includes: data annotation script information; the obtaining the first online training data according to the application algorithm information in the application requirement information includes: online collecting data annotation of data according to the data annotation script information, and generating the first online training data.

It ensures the accurate acquisition of online data used for online training of the algorithm model.

The application algorithm information includes an incentive feedback function; after deploying and releasing the target application according to the application resource, the operation environment and the application algorithm model, the method further includes: online updating the application algorithm model in the target application according to second online training data and the incentive feedback function.

It can support the continuous updating of the algorithm model and ensure the accuracy of the inference result of the application.

Furthermore, after deploying and releasing the target application, the method further includes: obtaining input data by using the target application, and analyzing the input data to obtain an application analysis result.

The input data in the embodiments of the present application can be understood as data to be processed.

It enables the use of the deployed and released application.

The obtaining the input data by using the target application includes: obtaining offline input data by using the target application, or obtaining online input data from a network management system; after obtaining the application analysis result, the method further includes: sending the application analysis result to the network management system.

It enables data interaction with the network management system.

The data processing method provided by the embodiments of the present application is described below with examples.

With respect to the above technical problems, the embodiments of the present application provide a data processing method, which can be specifically implemented as a general method for designing, orchestrating, and deploying a network intelligence application (also referred to as a general method for designing and orchestrating the network intelligence application). A user only needs to generate an intelligent application file compression package according to the template, load it to the application operation platform through an intelligent management and control platform (also referred to as an application management and control platform), automatically complete resource exploration, service configuration, network configuration (corresponding to the establishment of the real-time channel), and call a model training platform as needed to perform online training of the algorithm model (corresponding to the online iterative optimization support). This method can automatically obtain relevant data from the network environment and issue instructions, thereby realizing the automatic deployment and flexible operation of the network intelligent application. This solution enables automation in application deployment, operation, updating, and other operations, reduces manual operations, and improves efficiency and accuracy. Specifically, this solution involves the following parts.

### Part 1: Overall Introduction of the Solution

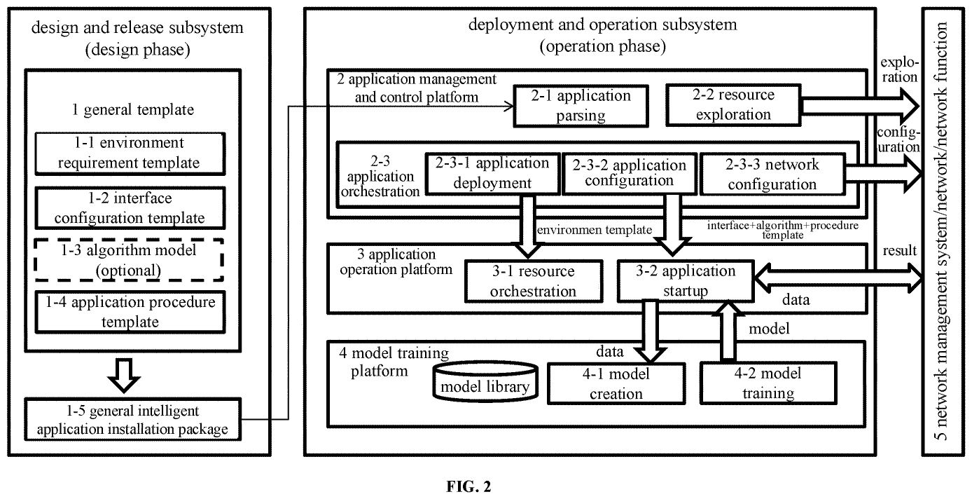

As shown in FIG. 2, firstly, this solution provides a general design template for releasing a network intelligent application (corresponding to the preset template information), including: an algorithm environment sub-template (corresponding to the environment requirement template in FIG. 2), an interface configuration sub-template (corresponding to the interface configuration template in FIG. 2), an algorithm model sub-template (corresponding to the algorithm model in FIG. 2) and an intelligent application procedure sub-template (corresponding to the application procedure template in FIG. 2). These four sub-templates contain all the information that the user-customized network intelligent application can be automatically deployed, released and operated on the intelligent platform. The user can generate corresponding files for each template format according to the intelligent application requirement (corresponding to the above-mentioned function requirement information). For example, the user can add specific parameter information according to the application requirement, and then generate files. These files can be packaged into an intelligent application file compression package (corresponding to the intelligent application installation package in FIG. 2). In this solution, the compression package can be used to compress transmission data to increase a transmission speed and save transmission resource. Additionally, multiple files can be compressed into a single file, and integrity verification and other content can be added to protect data privacy and integrity.

Secondly, this solution provides a deployment and operation subsystem for the design, release and deployment of the intelligent application, which is used to support the deployment, release and operation of the intelligent application on the general intelligent management and control platform (corresponding to the application management and control platform in FIG. 2). A function of the general intelligent management and control platform is mainly realized through three modules: application parsing, resource exploration and application orchestration. Specifically, the application parsing module supports decompression of the intelligent application file compression package uploaded by the user; the resource exploration module interacts with the application operation platform and the application network environment (corresponding to a network management system, a network and/or a network function in FIG. 2) to check and confirm an environment requirement (whether an operation environment resource requirement and an algorithm model operation environment condition are met, that is, whether the required resources are met) and a configuration requirement (whether a data interface and management and a control capability condition are met) of the intelligent application; the application orchestration module supports an environment creation, an application service configuration and application release and startup of the intelligent application (corresponding to application deployment, an application configuration and a network configuration in FIG. 2). The resource exploration module mainly explores whether the “network management system, network and/or network function” has the ability to support the data and result interaction with an “application startup” module in FIG. 2.

Finally, this solution provides a flexible and extensible general workflow for the release of the intelligent application. An application designer can fill a specific parameter into the general design template (corresponding to the general template under a design and release subsystem in FIG. 2) by designing a state system (corresponding to the design and release subsystem in FIG. 2) to generate files, and then package and generate a network intelligent application file compression package (corresponding to the intelligent application file compression package). An application consumer can decompress the intelligent application file compression package through the application management and control platform running the state system (corresponding to the deployment and operation subsystem in FIG. 2), parse the relevant configuration and interface of the operation environment, allocate relevant resources to the application on the application operation platform, and deploy and run the intelligent application (corresponding to the above-mentioned target application). The latter (i.e., the application operation platform) can perform deployment configuration, network docking, on-demand invocation of the model training platform to complete model training and other service configurations specific to a specific personalized requirement of the application based on the relevant content of the application procedure template obtained by parsing, thereby realizing a complete workflow.

Specifically, in this solution, the model training platform can correspond to a deep learning platform, which is used for model training; the application operation platform can correspond to a capability platform, which is used for online inference capability release; the application management and control platform can correspond to an Internet intelligence application platform, which is used for application-related environment docking, but the present disclosure is not limited thereto.

### Part 2, a General Design Template for Network Intelligent Application Design and Release (Corresponding to a General Template in FIG. 2)

This solution provides a general design template running on a general intelligent management and control platform. The user can use this template to generate relevant configuration and model files (corresponding to the above application requirements) and describe all the information for releasing, deploying and operating the intelligent application. This template comprises 4 sub-templates, with a function and format of each sub-template as described below.

1. An environment requirement sub-template (corresponding to an environment requirement template in FIG. 2 and corresponding to the above environment requirement information);
this template mainly describes the environment requirement for running the intelligent application, and can include the following basic requirements:
(1) OSEnv—Operating System Environment information for running an intelligent application, which can be described using the following fields:
Distr: name of the operating system, such as ubuntu;
Version: version of the operating system, for example 16.04;
(optional) Type: type of the operating system, such as 64-bit.
(2) AIEnv—Artificial Intelligence Engine information for running an intelligent application, which can be described using the following fields:
framework: name of the engine of the AI, such as tensorflow, Pytorch;
version: version of the AI engine, such as 2.0;
python_version: Python version, such as python: “3.5”;
libs: a third-party installation package that intelligent application depends on, such as the following public library functions:
jdk11;
urllib3;
numpy;
yaml;
. . .
(3) ComputeEnv—Computing Environment for running an intelligent application, which can be described using the following fields:
(optional) GPU: GPU (Graphics Processing Unit) resources required for running the application, e.g., 4 units.
(optional) CPU: CPU (Central Processing Unit) resources required for running the application, e.g., 8 cores.
(optional) mem (memory): memory resources required for running the application, e.g., 8 GB.
(optional) disk: disk storage resources, e.g., 256 GB.
(optional) mirror: mirror resources, e.g., 100 GB.
minInstances: minimum number of instances required for algorithm operation.

2. Interface configuration sub-template (corresponding to an interface configuration template in FIG. 2 and corresponding to the above interface configuration information);
this template is used to describe all data retrieval interfaces and control interface configuration information of the intelligent application, wherein the intelligent application obtains data from data sources through the data retrieval interface; the intelligent application makes decisions based on an analysis result and call a control interface to perform related network control. This template information is provided by the intelligent application platform (corresponding to a design and release subsystem in FIG. 2). The user can call some or all interfaces in the template (corresponding to the interface configuration template) in the algorithm flow file (corresponding to the application flow template) according to the data acquisition and network control requirement. The following interface information can be specifically defined in this template:
UeDataRetrieveAPI (User Equipment Data Retrieval Interface)—This interface is mainly used to obtain relevant status data information of a User Equipment (UE), such as a UE bandwidth, a connection status, a latency, etc.;
Resource Data Retrieve API (Resource Layer Data Retrieval Interface)—This interface is mainly used to obtain system-related data information from the resource layer, such as CPU utilization, pid (process ID of the operating system), etc.
NFDataRetrieveAPI (Network Function Data Retrieval Interface)—This interface is mainly used to obtain relevant status information of network functions, such as CPU utilization, a transmission rate, a packet loss rate, etc. of an Access and Mobility Management Function (AMF);
ResourceControlAPI (Resource Layer Control Interface)—This interface is used to issue a control command to the resource layer, such as restart and shutdown, based on the inference result of the algorithm model;
NFControlAPI (Network Function Control Interface)—This interface is used to issue the control command to a network function, such as scaling in and scaling out of the network function, based on the inference result of the algorithm model.

3. Algorithm model sub-template (optional), corresponding to the algorithm model in FIG. 2 and the application algorithm information;
this template is used to describe a neural network model that the user trains according to the intelligent application requirement. Different machine learning frameworks can be used to generate different model types. For example, using a TensorFlow framework to generate “.pb” type algorithm file; using a Keras framework to generate “.h5” type algorithm file; using the PyTorch framework, you can generate “.pt” type algorithm file;
if the user chooses to train an online model, this template may not be used.

4. Intelligent application procedure sub-template (corresponding to the application procedure template in FIG. 2 and the application procedure information);
this template provides all functions from data acquisition to decision execution. The user can call some of these functions according to the intelligent application operation requirement (i.e., service logic) to execute the entire process of the intelligent application. The following functions can be defined in this template:
getAPIs—used to obtain configuration information for all data interfaces and control interfaces;
getDataForAlgorithm—used to call the relevant data interface according to the algorithm requirement from all data interface configuration information to obtain the data required by the algorithm;
(optional) create_model—used to create an online neural network model (the user needs to set parameters such as a neural network type, a number of network connection layers, an activation function, a loss function, an optimization function, a learning rate, drop_out probability, and a number of training iterations when creating an online model);
(optional) trainRLAlgorithm—used to train the neural network intelligent algorithm (if the user chooses to create an online neural network model, this function needs to be called to train a neural network algorithm);
(optional) loadRLAlgorithm—used to load the neural network intelligent algorithm (if the user chooses to upload a trained algorithm model file according to an algorithm model template, this function can be called to load the uploaded algorithm model);
runRLAlgorithm—used to call an artificial intelligence algorithm to realize a complete workflow of the intelligent application (if the user has uploaded the algorithm model file according to the algorithm model sub-template, this function can be used to call the uploaded algorithm model; if the user chooses to create an online algorithm model, this function can be used to call an online-created model);
(optional) performAction—used to obtain a model analysis result and execute an operation through a network control interface;
(optional) getTrainDataForAlgorithm—used to call the relevant data interface according to the algorithm requirement from offline training dataset interface configuration information to obtain the data required for algorithm training;
DataAnnotation function—used to call the data annotation script file to annotate the data collected online.

Part 3, a management and control operation platform for network intelligent application deployment and release (corresponding to a deployment and operation subsystem in FIG. 2)

As shown in FIG. 2, this solution provides a general design template and operation method for releasing the intelligent application. The user needs to generate an intelligent application file compression package based on the general design template for releasing the intelligent application provided by this solution, upload it to the intelligent application management and control platform (corresponding to an application management and control platform in FIG. 2), decompress the intelligent application file compression package, parse the relevant configuration and interface of the operation environment, allocate relevant resource to the application on the application operation platform, deploy and run the intelligent application, and release the intelligent application.

The management and control operation platform in this solution mainly realizes the management and control operation of the intelligent application through a collaboration of the following three platforms.

### 1. Application Management and Control Platform

(1) Application parsing module:
this module is used to decompress the intelligent application file compression package to obtain the following files:
1) environment configuration file: contains the environment requirement for running the intelligent application;
2) interface configuration file: contains configuration information for all data retrieval interfaces and control interfaces of the intelligent application;
3) (optional) algorithm model file: the neural network model trained by the user according to the intelligent application requirement;
4) intelligent application procedure file: contains a function library file of all process functions used for intelligent applications from data acquisition to decision execution; the process execution file for the user to execute the entire process of the intelligent application according to the operation requirement of the intelligent application;
the application parsing module sends the above files to a corresponding configuration module (such as an application configuration module and a network configuration module in FIG. 2 for environment configuration and interface configuration).

5) Resource exploration module:
this module is used to parse the environment configuration file, interface configuration file and intelligent application procedure file to obtain application configurations such as an environment configuration, an interface configuration, a process configuration, etc. for releasing and operating the intelligent application. The module also verifies whether the network management (and/or network) environment and application operation platform can meet the requirement for intelligent application deployment, and then send the application configuration and the verification result to the application orchestration module.

6) Application orchestration module:
this module is used to receive the (application) configuration and result sent by the resource exploration module, and can perform the following three steps to complete the deployment and release of the service:
application deployment: used to call the resource orchestration module on the application operation platform to create an operation environment based on the environment resource template information;
application configuration: used to configure application execution environment based on the interface, algorithm, and procedure template information on the application operation platform; network configuration: used to configure the network environment according to the interface configuration template information through the network management system.

### 2. Application Operation Platform

(1) Resource orchestration module:
this module is used to create an operation environment based on the environment resource template information.
(2) Application startup module:
this module is used to configure the application operation environment, load the algorithm model, and execute the application procedure file to complete the application startup and online.

After the deployment and release of the intelligent application on the application operation platform, the intelligent application will start running. The intelligent application obtains the data required for the application operation from the corresponding data source according to the defined interface, calls the model training platform according to the defined workflow to complete the model training, and then performs corresponding model analysis and inference, and sends the analysis result or a management and control decision to the network management system. The network management system performs corresponding operations on the network and/or network function according to the analysis result or intelligent decision (such as: an alarm, an automatic repair, and other operations corresponding to the application function).

### 3. Model Training Platform

(1) Model library:
this module is used to store a model file imported externally or trained locally.
(2) Model creation module:
according to the model file specified by the application startup module of the application operation platform, the corresponding model is loaded from the model library, and the model training data docking and necessary data preprocessing are completed.
(3) Model training module:
this module is used to perform a model training task and package the trained model and deliver it to a calling application of the application operation platform to complete the online model update.

Part 4, general workflow for deploying and starting up the network intelligent application

To enable the actual deployment and operation of a third-party intelligent application on a general intelligent management and control platform, this solution provides the following workflow.

1. The intelligent management and control platform (i.e., application management and control platform) receives an intelligent application file compression package uploaded by the third party, and decompresses the file through the application parsing module to obtain: the environment configuration file (corresponding to the environment requirement information), the interface configuration file (corresponding to the interface configuration information), the model file (if the user uploads this file; corresponding to the application algorithm information) and the intelligent application procedure file (corresponding to the application procedure information), etc.

2. The application parsing module determines the required configuration information for deploying the intelligent application (corresponding to the application requirement information obtained based on the function requirement information and the preset template information) according to the environment configuration file, the interface configuration file, the model file (optional) and the intelligent application procedure file, and sends this information to a resource exploration module; wherein “determining the required configuration information for deploying the intelligent application” can be: directly reading the specific parameter information from the file or further processing the specific parameter information read from the file, which is not limited herein.

3. The resource exploration module checks whether the release environment and application platform (i.e., application operation platform) can meet the intelligent application deployment requirement (corresponding to the exploration of whether the target release environment resource and/or target operation platform resource meet the deployment and release requirement of the target application according to the application requirement information). If the requirement is met, the configuration parsing module (i.e., resource exploration module) sends the application configuration requirement to the application orchestration module and executes step 4; if the requirement is not met, an application deployment failure notification is sent to the user and the workflow ends;

4. The application orchestration module receives the environment requirement, interface configuration, algorithm model, and application process, and other model files, allocates relevant resources to the application on the application operation platform, creates an operation environment, and deploys and releases the intelligent application. This corresponds to allocating application resource to the target application from the target operation platform resource according to the application requirement information, creating an operation environment for the target application; and deploying and releasing the target application according to the application resource and operation environment;

5. The intelligent application obtains data from the data source as needed according to the application process design, loads the algorithm model (when uploading the algorithm model file) or calls the model training platform for model training (when the user creates an online model in the process file), and the algorithm model performs inference analysis, outputs the analysis result and intelligent decision and distributes them to the management and control module (corresponding to the network management system/network/network function in FIG. 2 and the network management system). The management and control module performs the corresponding operation according to the analysis result and decision. This corresponds to obtaining offline input data by using the target application or online input data from the network management system, and analyzing the data to obtain the application analysis result; and sending the application analysis result to the network management system.

The following are specific examples of the solution provided by the embodiments of the present application.

This solution uses the network fault analysis scenario as an example application: a user customizes a network fault detection application, and obtains environment resource information, core network function information and system status information. The user utilizes the intelligent application template provided by this solution to develop and design the intelligent application for this scenario. The application is actually deployed and run on the application platform. It continuously collects real-time data and performs analysis to locate a network fault (for example, memory, CPU, hard disk overload; network card congestion or interruption, excessive packet loss rate; network port closure; operation environment or virtual machine interruption, etc.).

### Embodiment 1: Offline Training Model

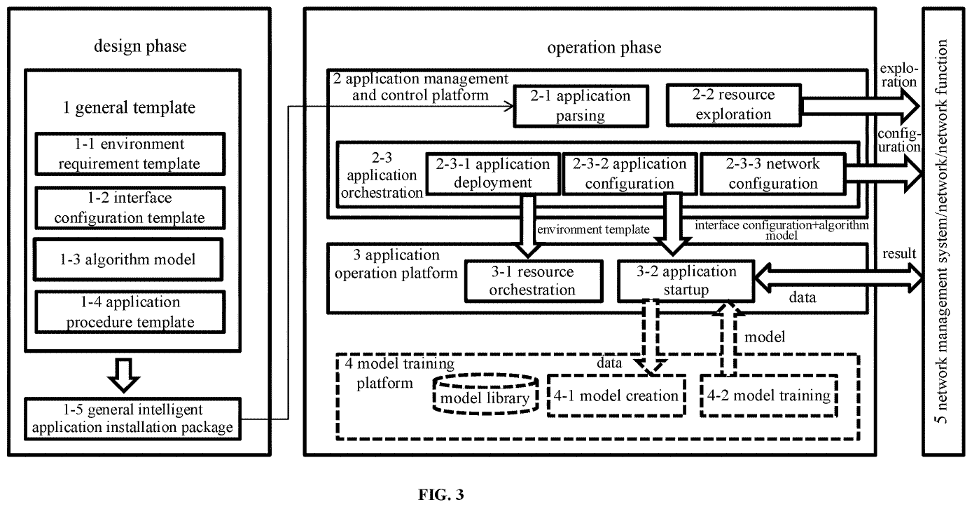

As shown in FIG. 3, the specific steps of this embodiment may be as follows.

1. According to the requirement of the embodiment of the network fault detection intelligent application, the user creates an intelligent application file applicable to this embodiment. The specific contents of the file are as follows.

(1) According to the environment requirement sub-template, the user creates the environment requirement file “Env.yaml” for this embodiment, which is used to describe basic requirement information of the operation environment, an AI intelligent engine, and computing environment for a network fault detection algorithm system. The specific contents are as follows:

```
OSEnv: //operating system environment;
  distr: ubuntu//name of the operating system;
  version: 18.04 //version number;
AIEnv: //AI environment;
  framework: tensorflow//learning framework;
  version: “2.0” //version;
  python: “3.5” //programming language version;
  lib://dependent library functions;
    yaml;
    urllib3;
    json;
    numpy;
ComputeEnv: //computing environment;
  GPU: 1 //the recommended number of GPUs to allocate;
  minInstances: 1 //minimum number of instances.
```

The above information describes the environment requirements of this embodiment as follows:
the system operation environment is Ubuntu version 18.04;
the AI engine is TensorFlow version 2.0;
the third-party installation packages required for running the intelligent application include python, yaml, urllib3, json, and numpy;
the computing environment is a GPU and the minimum algorithm instance is 1.

(2) According to the interface configuration sub-template, a general intelligent management and control platform provides an interface configuration file “api.yaml” which is used to describe all data retrieval interfaces and network control interface configurations that can be called by the user in this embodiment. The file may contain the following interface call addresses:

```
UeDataRetrieveAPI: //UE data retrieval interface;
  overallUri: “/getCurrentUEStatus”;
ResourceDataRetrieveAPI: //resource data retrieval interface;
  overallUri: //general prefix;
“/getCurrentSystemStatus”;
  cpuUri: “/getCPUData” //cpu suffix;
  memUri: “/getMemData” //mem suffix;
NFDataRetrieveAPI: //NF data retrieval interface;
  overallUri: //general prefix;
“http://quan.suning.com/getSysTime.do”;
ResourceControlAPI: //resource control interface;
instanceManagementUri:”http://127.0.0.1:8081/NFInstance”;
NFControlAPI: //NF control interface;
  startNFUri: //startup interface;
“https://api.zb.work/data/v1/”.
```

The above information describes the specific details of the available data retrieval interface and control interface of this embodiment as follows:
UeDataRetrieveAPI represents the user data retrieval interface;
ResourceDataRetrieveAPI represents the resource layer data retrieval interface, which may include: overallUri resource layer data retrieval overall interface, cpuUri CPU data retrieval interface and memUri memory data retrieval interface;
NFDataRetrieveAPI represents the network function data retrieval interface;
ResourceControlAPI represents the resource layer control interface;
NFControlAPI represents the network function control interface;
instanceManagementUri represents the instance management interface;
startNFUri represents startup management interface.

(3) According to the algorithm configuration sub-template (i.e., the algorithm model sub-template), the user creates an algorithm model file “model.pb” for this embodiment. This model is a trained Convolutional Neural Network (CNN) with 100 layers. The network is configured with a Relu activation function, a mean square error loss function, and Adam optimizer. This corresponds to obtaining a trained application algorithm model according to the application algorithm information provided in the application requirement information.

In this use case, the algorithm model can be used to obtain network resource information, network function status information, and user status information data, perform inference, and output a network fault analysis result.

(4) Performing the following operations according to the intelligent application procedure sub-template.
1) First, the platform (i.e., the application management and control platform) provides a function library file “common.py” for this embodiment, wherein the function library file provides functions that can be executed in this embodiment, including:
getAPI( ) function, used to obtain, from the interface configuration file, the data acquisition and control interface information used in this embodiment;
getDataForAlgorithm( ) function, used to call the relevant data interface to obtain the data required by the algorithm from all data interface configuration information according to the algorithm requirement;
loadRLAlgorithm( ) function, used to load the algorithm model file in the operation environment;
runRLAlgorithm( ) function, used to input the data required to run the algorithm model, allowing the algorithm to perform inference to obtain a network analysis result.

2) The user creates an application procedure file “procedure.py” according to the function library file “common.py” provided by the platform, and calls the following functions in “common.py” in “procedure.py” according to the application service logic of the embodiment:
calling the getAPI( ) function to obtain a data acquisition and control interface Uniform Resource Identifier (URI) used by this embodiment to acquire the data and output a decision from “api.yaml”;
calling the getDataForAlgorithm( ) function to obtain the CPU utilization, memory utilization, latency, packet loss rate and status data information of core network functions (such as an AMF, a Session Management Function (SMF), an Authentication Server Function (AUSF), a User Plane Function (UPF), a Unified Data Management (UDM), a Unified Data Repository (UDR), a Unstructured Data Storage Function (UD SF) and a Network Repository Function (NRF)) from NFDataRetrieveAPI; obtaining the bandwidth, delay (pingDelay) and status data information of the UE from the user data interface (UE DataAPI); obtaining the GPU utilization, hard disk utilization, memory utilization, ip, pid and other information of a resource layer from ResourceDataRetrieveAPI;
calling the loadRLAlgorithm( ) function to load the “model.pb” file (a trained fully connected CNN neural network algorithm model) in the operation environment;
calling the runRLAlgorithm( ) function to input the data obtained from the getDataForAlgorithm( ) function into the loaded algorithm model, executing inference using the neural network, and returning the analysis result. For example, if the inference result indicates a fault in the amf service, the output is “amf service down”; if the inference result indicates no network fault, the output is “network is ok”.

The intelligent application procedure sub-template is used to periodically complete the data collection of various dimensions of the resource layer, operation environment layer and network function layer in this embodiment, and perform the network fault analysis and inference according to the trained model. If a network fault is detected, the network fault location result is output.

2. Compressing the above design files into a universal intelligent application package “app.tar” (i.e., intelligent application file compression package), and upload it to the application management and control platform.

3. The application management and control platform decompresses the design file and decompresses “app.tar” through the application parsing module to obtain the environment requirement file “Env.yaml”, the interface configuration file “api.yaml”, the model file “model.pb”, the intelligent application process function library file “common.py”, and the intelligent application procedure file “procedure.py”.

4. The application parsing module sends “Env.yaml”, “api.yaml”, “model.pb”, “common.py” and “procedure.py” to the resource exploration module.

5. The resource exploration module receives the file sent by the application parsing module and parses the environment information required for deploying the intelligent application, such as:
the system operation environment is Ubuntu version 18.04;
the AI engine is TensorFlow version 2.0;
the third-party installation packages required for running the intelligent application include python, yaml, urllib3, json, and numpy;
the computing environment is an 8-core GPU, and the minimum required algorithm instance is 1.

6. The resource exploration module checks whether the release environment and application platform can meet the requirement for intelligent application deployment. If the requirement is met, the configuration parsing module sends the application configuration requirement to the application orchestration module and executes step 7. If the requirement is not met, an application deployment failure notification is sent to an intelligent application consumer and the workflow ends.

7. The application orchestration module receives the configuration sent by the configuration parsing module and completes the deployment and release of the intelligent application, including:
(1) sending interface configuration template information to the network management system to complete network environment configuration;
(2) sending environment requirement information, process configuration, interface configuration, and algorithm model information to the resource orchestration module and application startup module in the application operation platform.

8. The application operation platform receives the configuration information sent by the application orchestration module and executes the application procedure file to complete the application startup and operation (corresponding to the deployment and release of the target application according to the application resource, operation environment and application algorithm model), including:
(1) the resource orchestration module prepares the docker operation environment for application deployment according to the environment template information, by using the Kubernetes controller according to the environment information (corresponding to the above environment requirement information);
(2) the application online module (i.e., the application startup module) configures the application execution environment according to the received interface configuration template information (corresponding to the interface configuration), algorithm model template information (corresponding to the algorithm model information), and application procedure template information (corresponding to the process configuration), configures the application operation environment, and loads the algorithm model:
1) calling the getAPI( ) function and getDataForAlgorithm( ) function through “procedure.py” to obtain the raw data required by the algorithm from the data retrieval interface and input it into the docker for running the algorithm model;
2) calling the loadRLAlgorithm( ) function through “procedure.py” to load the “model.pb” file in the operation environment to obtain the trained algorithm model;
3) calling the runRLAlgorithm( ) function through “procedure.py” to input the required data into the algorithm model. The algorithm model performs analysis and inference on the input data to obtain the network fault analysis and location result;
4) notifying the intelligent application consumer (operation and maintenance personnel management interface or network management system) of the network fault analysis and location result.

### Embodiment 2: Offline Data Collection and Online Model Training

In this embodiment, the installation package carries the training data, or a download link for the training data. The application configuration steps are adjusted accordingly to enable the integration of the training data download process. The application process template is modified to enable model creation, data import, and model training steps.

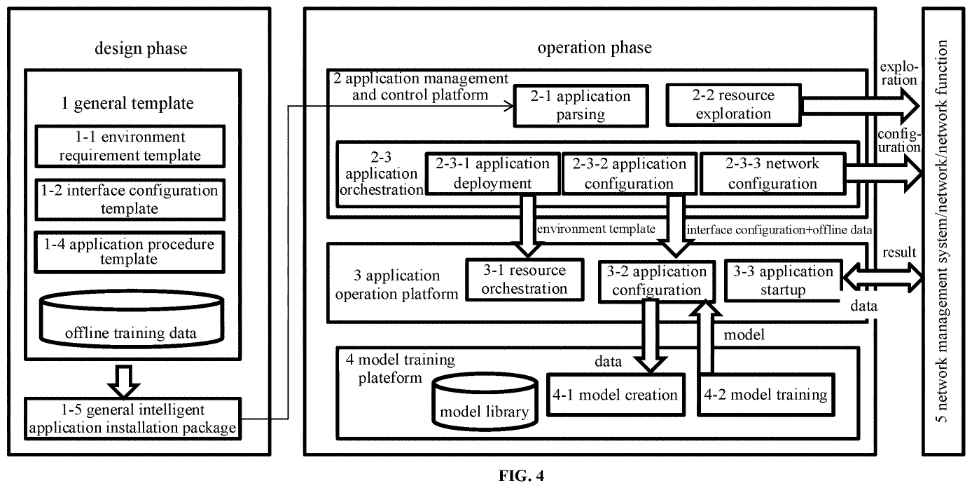

As shown in FIG. 4, the specific steps of this embodiment may be as follows.

1. According to a requirement of the embodiment of the network fault detection intelligent application, a user creates an intelligent application file applicable to this embodiment. The specific contents of the file are as follows.

(1) According to the environment requirement sub-template, the user creates the same environment requirement file “Env.yaml” for this embodiment as in embodiment 1, which is used to describe basic requirement information of the operation environment, the AI intelligent engine, and the computing environment for the network fault detection algorithm system.

(2) According to the interface configuration sub-template, the application management and control platform provides the same interface configuration file “api.yaml” as in the embodiment 1, which is used to describe all data retrieval interfaces and network control interface configurations that can be called by the user in this embodiment.

(3) According to an algorithm requirement of the embodiment, the user provides an offline training dataset configuration interface file “train.yaml” for the algorithm training of this embodiment. The training dataset size can be set to 1000, and the training dataset includes input data such as the relevant status data of a core network function, a UE and a GPU, and corresponding labels, such as AMF shutdown, SMF shutdown, CPU overload, UPF network card delay and UPF network card packet loss, etc. Specifically, it may include the following configuration information:

```
TrainDataAPI: //training data interface;
  ftpUri: “127.0.0.1:8081” //FTP access address;
  Dataname: “Traindata” //data name;
  Username: “ABC” //username;
  Password: “123456” //password.
```

The above information describes the specific information of the available data retrieval interface and control interface of this embodiment, as follows:

```
TrainDataAPI: training dataset retrieval interface;
  ftpUri: dataset access address;
  Dataname: data name;
  Username: username;
  Password: access password.
```

(4) According to an algorithm procedure sub-template (i.e., intelligent application procedure sub-template), it performs the following operations.

1) The platform provides a function library file “common.py” for this embodiment, wherein the function library file provides functions that can be used to execute this embodiment, including:
getAPI( ) function, used to obtain the data acquisition and control interface information used in this embodiment from the interface configuration file;
getTrainDataForAlgorithm( ) function, used to call the relevant data interface according to the algorithm requirement from the offline training dataset interface configuration information to obtain the data required for algorithm training;
getDataForAlgorithm( ) function, used to call the relevant data interface to obtain the data required by the algorithm from all data interface configuration information according to the algorithm requirement;
create_model( ) function, used to create an online neural network model according to a network fault detection requirement;
trainRLAlgorithm( ) function, used to train the neural network algorithm created online;
runRLAlgorithm( ) function, used to input the data required to run the algorithm model, allowing the algorithm to perform inference to obtain a network analysis result.

2) The user creates an application procedure file “procedure.py” according to the function library file “common.py” provided by the platform, and calls the following functions in “common.py” in “procedure.py” according to an application service logic of the embodiment:
a) calling the getAPI( ) function to obtain the data acquisition and control interface URI and offline training dataset URI used in this embodiment to acquire data and output a decision from “api.yaml” and “train.yaml”;
b) calling the getTrainDataForAlgorithm( ) function to obtain the training dataset for the algorithm model of the embodiment from the TrainDataAPI;
c) calling the getDataForAlgorithm( ) function to obtain the CPU utilization, memory utilization, latency, packet loss rate and status data information of the core network functions (such as an AMF, an SMF, an AUSF, a UPF, a UDM, a UDR, a UDSF and an NRF) from the NFDataRetrieveAPI; obtaining the bandwidth, pingDelay and status data information of the UE from the UE DataAPI; obtaining the GPU utilization, hard disk utilization, memory utilization, ip, pid and other information of a resource layer from ResourceDataRetrieveAPI;
d) calling the create_model( ) function to create a neural network model for network fault detection online, which can be represented by the following fields:

```
define model creation (the model itself):
  model = sequential ([
    fully-connected layer (input, input_dimension=9, activation=‘Relu’),
    fully connected layer (input, activation = ‘Relu’),
    fully connected layer (output dimension = 10),
  ])
  model compile (loss function = ‘mean square error’,
  optimizer = optimizers.Adam (0.001),
  evaluation metric = [‘accuracy’]
      )
  return model.
```

The above information describes that the model is a 3-layer fully connected neural network. The Relu activation function, mean square error loss function, Adam optimizer are set in the network. The evaluation metric is accuracy. The number of input neurons is 9 and the number of output neurons is 10;
e) calling the trainRLAlgorithm( ) function to train the neural network algorithm created online using the training dataset provided by the user, setting Batch_Size to 64, Epoch to 50, and using 20% of the data for validation;
f) calling the runRLAlgorithm( ) function to input the data obtained from the getDataForAlgorithm( ) function into the loaded algorithm model, executing inference using the neural network, and returning the analysis result. For example, if the inference result indicates a fault in the amf service, the output is “amf service down”; if the inference result indicates no network fault, the output is “network is ok”.

The intelligent application procedure sub-template is used to periodically complete the data collection of various dimensions of the resource layer, operation environment layer and network function layer in this embodiment, and perform the network fault analysis and inference according to the trained model. If a network fault is detected, the network fault location result is output.

2. Compress the above design files into a compressed file “app.tar” and upload it to the intelligent application releasing platform (i.e. application management and control platform).

3. The application management and control platform decompresses the design file and decompresses “app.tar” through the application parsing module to obtain the environment requirement file “Env.yaml”, the interface configuration file “api.yaml”, the offline training data interface configuration file “train.yaml”, the intelligent application process function library file “common.py” and the intelligent application procedure file “procedure.py”.

4. The application parsing module sends “Env.yaml”, “api.yaml”, “train.data”, “common.py”, and “procedure.py” to the configuration parsing module (i.e., the resource exploration module).

5. The configuration parsing module receives the file sent by the application parsing module and parses the environment information required for deploying the intelligent application, such as:
the system operation environment is Ubuntu version 18.04;
the AI engine is TensorFlow version 2.0;
the third-party installation packages required for running intelligent applications include python, yaml, urllib3, json, and numpy;
the computing environment is an 8-core GPU, and the minimum required algorithm instance is 1.

6. The resource exploration module checks whether the release environment and application platform can meet the requirement for intelligent application deployment. If the requirement is met, the configuration parsing module sends the application configuration requirements to the application orchestration module and executes step 7. If the requirement is not met, an application deployment failure notification is sent to an intelligent application consumer and the workflow ends.

7. The application orchestration module receives the configuration sent by the configuration parsing module and completes the deployment and release of the intelligent application, including:
(1) sending interface configuration template information to the network management system to complete network environment configuration;
(2) sending environment requirement information, process configuration, and interface configuration information to the resource orchestration module and application startup module in the application operation platform.

8. The application operation platform receives the configuration information sent by the application orchestration module and executes the application procedure file to complete the application startup and operation (corresponding to the deployment and release of the target application according to the application resource, the operation environment and the application algorithm model), including the following.

(1) The resource orchestration module prepares the docker operation environment for application deployment according to the environment template information, using the Kubernetes controller according to the environment configuration.

(2) The application startup module sends the algorithm procedure template information and the training data uploaded by the user to a model training module (i.e., the “training model” module in the model training platform) to perform model creation and model training (corresponding to the acquisition of offline training data according to the application algorithm information in the application requirement information; and online training according to the offline training data to obtain the application algorithm model), including:
calling the create_model( ) function through “procedure.py” to create a neural network model for network fault detection online;
calling the getAPI( ) function and getTrainDataForAlgorithm( ) function through “procedure.py” to import the training dataset;
calling the trainRLAlgorithm( ) function through “procedure.py” to train the neural network algorithm created online.

(3) The application online module (i.e., application startup module) configures the application execution environment according to the received interface configuration template information (corresponding to the interface configuration) and application procedure template information (corresponding to the process configuration), configures the application operation environment, and calls the model training platform (service) to create and train the algorithm model, including the following:
calling the getAPI( ) function and getDataForAlgorithm( ) function through “procedure.py” to obtain the raw data required by the algorithm from the data retrieval interface, and input it into the docker for running the algorithm model;
calling the runRLAlgorithm( ) function through “procedure.py” to input the required data into the algorithm model. The algorithm model performs analysis and inference on the input data to obtain the network fault analysis and location result;
notifying the intelligent application consumer (operation and maintenance personnel management interface or network management system) of the network fault analysis and location result.

### Embodiment 3: Online Data Collection and Online Model Training

In this embodiment, an installation package carries a data annotation script, or a general service reference link; corresponding adjustments are made in the application procedure template to enable online data annotation, data import and model training steps.

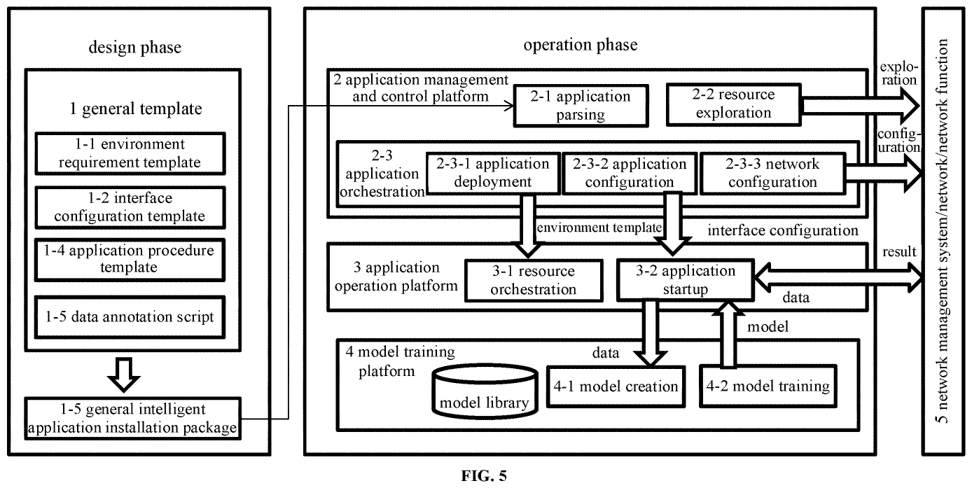

As shown in FIG. 5, the specific steps of this embodiment may be as follows.

1. According to the requirement of the network fault detection intelligent application embodiment, the user creates an intelligent application file applicable to this embodiment. The specific contents of the file are as follows.

(1) According to the environment requirement sub-template, the user creates the same environment requirement file “Env.yaml” for this embodiment as in embodiment 1, which is used to describe basic requirement information of network fault detection algorithm system operation environment, an AI intelligent engine, and computing environment.

(2) According to the interface configuration sub-template, the application management and control platform provides an interface configuration file “api.yaml” which is used to describe all data retrieval interfaces and network control interface configurations that can be called by the user in this embodiment (the same interface is called for online training data).

(3) According to the requirement of the embodiment, the user provides a data annotation script file to perform data annotation of the online collected data and generate an online training dataset (corresponding to the application algorithm information including: data annotation script information; online collecting data annotation of data according to the data annotation script information, and generating the first online training data).

(4) According to an algorithm procedure sub-template (i.e., intelligent application procedure sub-template), it performs the following operations.

1) The platform provides a function library file “common.py” for this embodiment, wherein the function library file provides functions that can be used to execute this embodiment, including:
getAPI( ) function, used to obtain the data acquisition and control interface information used in this embodiment from the interface configuration file;
getDataForAlgorithm( ) function, used to call the relevant data interface to obtain the data required by the algorithm (training and inference) from all data interface configuration information according to the algorithm requirement;
create_model( ) function, used to create an online neural network model according to the network fault detection requirement;
DataAnnotation( ) function, used to call the data annotation script file to annotate the data collected online;
trainRLAlgorithm( ) function, used to train the neural network algorithm created online;
runRLAlgorithm( ) function, used to input the data required to run the algorithm model, allowing the algorithm to perform inference to obtain a network analysis result.

2) The user creates an application procedure file “procedure.py” according to the function library file “common.py” provided by the platform, and calls the following functions in “common.py” in “procedure.py” according to an application service logic of the embodiment.
a) calling the getAPI( ) function to obtain a data acquisition and control interface URI used by this embodiment to acquire data and output a decision from “api.yaml”;
b) calling the getDataForAlgorithm( ) function to obtain the CPU utilization, memory utilization, latency, packet loss rate and status data information of the core network functions (such as an AMF, an SMF, an AUSF, a UPF, a UDM, a UDR, a UDSF and an NRF) from the NFDataRetrieveAPI; obtaining the bandwidth, pingDelay and status data information of the UE from the UE DataAPI; obtaining the GPU utilization, hard disk utilization, memory utilization, ip, pid and other information of a resource layer from ResourceDataRetrieveAPI;
c) calling the DataAnnotation( ) function to annotate the data obtained online using the data annotation script provided by the user and generate an online training dataset;
d) calling the create_model( ) function to create a neural network model for network fault detection online, which can be represented by the following fields:

```
define model creation (the model itself):
  model = sequential ([
    fully-connected layer(input, input_dimension=9, activation =‘Relu’),
    fully connected layer (input, activation = ‘Relu’),
    fully connected layer (output dimension = 10),
  ])
  model compile (loss function = ‘mean square error’,
  optimizer = optimizers.Adam (0.001),
  evaluation metric = [‘accuracy’]
      )
  return model.
```

this description specifies that the model is a 3-layer fully connected neural network. The Relu activation function, mean square error loss function, Adam optimizer are set in the network. The evaluation metric is accuracy. The number of input neurons is 9 and the number of output neurons is 10;
e) calling the trainRLAlgorithm( ) function to train the neural network algorithm created online, setting Batch_Size to 64, Epoch to 50, and using 20% of the data for validation.
f) calling the runRLAlgorithm( ) function to input the data obtained from the getDataForAlgorithm( ) function into the loaded algorithm model, executing inference using the neural network, and returning the analysis result. For example, if the inference result indicates a fault in the amf service, the output is “amf service down”; if the inference result indicates no network fault, the output is “network is ok”.

The intelligent application procedure sub-template is used to periodically complete the data collection of various dimensions of the resource layer, operation environment layer and network function layer in this embodiment, and perform network fault analysis and inference according to the trained model. If a network fault is detected, the network fault location result is output.

2. Compress the above design files into a compressed file “app.tar” and upload it to the intelligent application releasing platform (i.e. application management and control platform).

3. The application management and control platform decompresses the design file and decompresses the compressed file “app.tar” through the application parsing module to obtain the environment requirement file “Env.yaml”, the interface configuration file “api.yaml”, the data annotation script, the intelligent application process function library file “common.py” and the intelligent application procedure file “procedure.py”.

4. The application parsing module sends “Env.yaml”, “api.yaml”, “common.py” and “procedure.py” to the configuration parsing module (i.e., resource exploration module).

5. The configuration parsing module receives the file sent by the application parsing module and parses the environment information required for deploying the intelligent application, such as:
the system operation environment is Ubuntu version 18.04;
the AI engine is TensorFlow version 2.0;
the third-party installation packages required for running intelligent applications include python, yaml, urllib3, json, and numpy;
the computing environment is an 8-core GPU, and the minimum required algorithm instance is 1.

6. The resource exploration module checks whether the release environment and application platform can meet the requirement for intelligent application deployment. If the requirement is met, the configuration parsing module sends the application configuration requirements to the application orchestration module and executes step 7. If the requirement is not met, an application deployment failure notification is sent to an intelligent application consumer and the workflow ends.

7. The application orchestration module receives the configuration sent by the configuration parsing module and completes the deployment and release of the intelligent application, including:
(1) sending interface configuration template information to the network management system to complete network environment configuration;
(2) sending environment requirement information, process configuration, and interface configuration information to the resource orchestration module and application startup module in the application operation platform.

8. The application operation platform receives the configuration information sent by the application orchestration module and executes the application procedure file to complete the application startup and operation (corresponding to the deployment and release of the target application according to the application resource, operation environment and application algorithm model), including the following.

(1) The resource orchestration module prepares the docker operation environment for application deployment according to the environment template information, using the Kubernetes controller according to the environment configuration.

(2) The application startup module collects online training data according to the algorithm procedure template information and sends it to the model training module (i.e., the “training model” module in the model training platform), executes model creation (corresponding to the acquisition of the first online training data according to the application algorithm information in the application requirement information; and obtaining the application algorithm model through online training according to the first online training data). Simultaneously, it continuously collects data online and performs data annotation (corresponding to the application algorithm information including: data annotation script information; and online collecting data annotation of data according to the data annotation script information, and generating the first online training data), completing the model training, which includes:
calling the create_model( ) function through “procedure.py” to create a neural network model for network fault detection online;
calling the getAPI( ) function and getDataForAlgorithm( ) function through “procedure.py” to obtain the online training data required by the algorithm from the data retrieval interface, and input it into the docker for running the algorithm model;
calling the DataAnnotation( ) function through “procedure.py” to annotate the online collected data and generate a training dataset;
calling the trainRLAlgorithm( ) function through “procedure.py” to train the neural network algorithm created online using the training dataset.

(3) The application online module (i.e., application startup module) configures the application execution environment according to the received interface configuration template information (corresponding to the interface configuration) and application procedure template information (corresponding to the process configuration), configures the application operation environment, and calls the model training platform (service) to create and train the algorithm model, including the following:
calling the getAPI( ) function and getDataForAlgorithm( ) function through “procedure.py” to obtain the raw data required by the algorithm from the data retrieval interface, and input it into the docker for running the algorithm model;
calling the loadRLAlgorithm( ) function through “procedure.py” to obtain the trained algorithm model;
calling the runRLAlgorithm( ) function through “procedure.py” to input the required data into the algorithm model. The algorithm model performs analysis and inference on the input data to obtain the network fault analysis and location result;
notifying the intelligent application consumer (operation and maintenance personnel management interface or network management system) of the network fault analysis and location result.

### Embodiment 4: Online Continuous Training Model

In this embodiment, the installation package carries an online learning algorithm model, or a general model reference link (which includes an incentive feedback function); corresponding adjustments are made in an application procedure template to enable online incentive calculation, incentive feedback and model training steps.

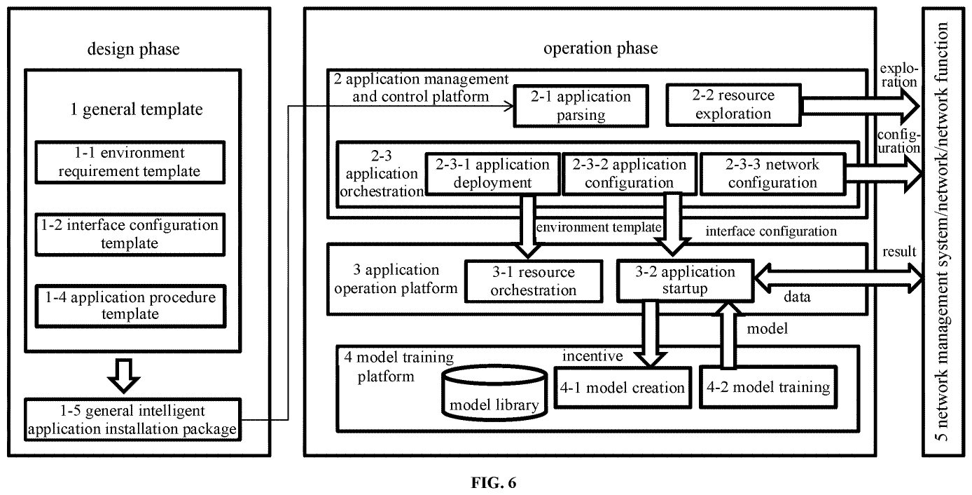

As shown in FIG. 6, the specific steps of this embodiment may be as follows.

1. According to the requirement of the embodiment of the network fault detection intelligent application, the user creates an intelligent application file applicable to this embodiment. The specific contents of the file are as follows.

(1) According to the environment requirement sub-template, the user creates the same environment requirement file “Env.yaml” for this embodiment as in embodiment 1, which is used to describe the basic requirement information of the network fault detection algorithm system operation environment, an AI intelligent engine, and computing environment.

(2) According to the interface configuration sub-template, the application management and control platform provides an interface configuration file “api.yaml”, which is used to describe all data retrieval interfaces and network control interface configurations that can be called by the user in this embodiment (the same interface is called for online training data).

(3) According to the requirement of the embodiment, the user provides a data annotation script file to perform data annotation of the online collected data and generate an online training dataset (similar to the above-mentioned application algorithm information including: data annotation script information; online collecting data annotation of data according to the data annotation script information, and generating the first online training data).

(4) According to the requirement of the embodiment, the end user or the platform provides an accuracy feedback function file of an intelligent fault localization deep neural network according to a default setting. When the intelligent fault localization algorithm infers correctly, a large reward is provided; when it infers incorrectly, a negative reward is given. If the intelligent fault localization algorithm makes a significant mistake in judgment, the network will be retrained based on the previously trained model.

(5) According to an algorithm procedure sub-template (i.e., intelligent application procedure sub-template), it perform the following operations.

1) The platform provides a function library file “common.py” for this embodiment, wherein the function library file provides functions that can be used to execute this embodiment, including:
getAPI( ) function, used to obtain the data acquisition and control interface information used in this embodiment from the interface configuration file;
getDataForAlgorithm( ) function, used to call the relevant data interface to obtain the data required by the algorithm (training and inference) from all data interface configuration information according to the algorithm requirement;
create_model( ) function, used to create an online neural network model according to the network fault detection requirement;
DataAnnotation( ) function, used to call the data annotation script file to annotate the data collected online;
trainRLAlgorithm( ) function, used to train the neural network algorithm created online;
runRLAlgorithm( ) function, used to input the data required to run the algorithm model, allowing the algorithm to perform inference to obtain a network analysis result.

2) The user creates an application procedure file “procedure.py” according to the function library file “common.py” provided by the platform, and calls the following functions in “common.py” in “procedure.py” according to an application service logic of the embodiment:
a) calling the getAPI( ) function to obtain a data acquisition and control interface URI used by this embodiment to acquire data and output a decision from “api.yaml”;
b) calling the getDataForAlgorithm( ) function to obtain the CPU utilization, memory utilization, latency, packet loss rate and status data information of the core network functions (such as an AMF, an SMF, an AUSF, a UPF, a UDM, a UDR, a UDSF and an NRF) from the NFDataRetrieveAPI; obtaining the bandwidth, pingDelay and status data information of the UE from the UE DataAPI; obtaining the GPU utilization, hard disk utilization, memory utilization, ip, pid and other information of a resource layer from ResourceDataRetrieveAPI;
c) calling the DataAnnotation( ) function to annotate the data obtained online using the data annotation script provided by the user and generate an online training dataset;
d) calling the create_model( ) function to create a neural network model for network fault detection online, which can be represented by the following fields:

```
define model creation (the model itself):
  model = sequential ([
    fully-connected layer (input, input_dimension=9, activation =‘Relu’),
    fully connected layer (input, activation = ‘Relu’),
    fully connected layer (output dimension = 10),
  ])
model compilation (loss function = ‘mean square error’,
optimizer = optimizers.Adam (0.001),
evaluation index = [‘accuracy’]
      )
return model.
```

this description specifies that the model is a 3-layer fully connected neural network. The Relu activation function, mean square error loss function, Adam optimizer are set in the network. The evaluation index is accuracy. The number of input neurons is 9 and the number of output neurons is 10;
e) calling the trainRLAlgorithm( ) function to train the neural network algorithm created online, setting Batch_Size to 64, Epoch to 50, and using 20% of the data for validation.
f) calling the runRLAlgorithm( ) function to input the data obtained from the getDataForAlgorithm( ) function into the loaded algorithm model, executing inference using the neural network, and returning the analysis result. For example, if the inference result indicates a fault in the amf service, the output is “amf service down”; if the inference result indicates no network fault, the output is “network is ok”.

The intelligent application procedure sub-template is used to periodically complete the data collection of various dimensions of the resource layer, operation environment layer and network function layer in this embodiment, and perform network fault analysis and inference according to the trained model. If a network fault is detected, the network fault location result is output.

2. Compress the above design files into a compressed file “app.tar” and upload it to the intelligent application releasing platform (i.e. application management and control platform).

3. The application management and control platform decompresses the design file and decompresses the compressed file “app.tar” through the application parsing module to obtain the environment requirement file “Env.yaml”, the interface configuration file “api.yaml”, the data annotation script, the accuracy feedback function file, the intelligent application process function library file “common.py” and the intelligent application procedure file “procedure.py”.

4. The application parsing module sends “Env.yaml”, “api.yaml”, “common.py” and “procedure.py” to the configuration parsing module (i.e., resource exploration module).

5. The configuration parsing module receives the file sent by the application parsing module and parses the environment information required for deploying the intelligent application, such as:
the system operation environment is Ubuntu version 18.04;
the AI engine is TensorFlow version 2.0;
the third-party installation packages required for running intelligent applications include python, yaml, urllib3, json, and numpy;
the computing environment is an 8-core GPU, and the minimum required algorithm instance is 1.

6. The resource exploration module checks whether the release environment and application platform can meet the requirement for intelligent application deployment. If the requirement is met, the configuration parsing module sends the application configuration requirement to the application orchestration module and executes step 7. If the requirement is not met, an application deployment failure notification is sent to an intelligent application consumer and the workflow ends.

7. The application orchestration module receives the configuration sent by the configuration parsing module and completes the deployment and release of the intelligent application, including:
(1) sending interface configuration template information to the network management system to complete network environment configuration;
(2) sending environment requirement information, process configuration, and interface configuration information to the resource orchestration module and application startup module in the application operation platform.

8. The application operation platform receives the configuration information sent by the application orchestration module and executes the application procedure file to complete the application startup and operation (corresponding to the deployment and release of the target application according to the application resource, operation environment and application algorithm model), including the following.

(1) The resource orchestration module prepares the docker operation environment for application deployment according to the environment template information, by using the Kubernetes controller according to the environment information.

(2) The application startup module collects online training data according to the algorithm procedure template information and sends it to a model training platform to execute model creation (which may correspond to the acquisition of the first online training data according to the application algorithm information in the application requirement information; and the online training to obtain the application algorithm model according to the first online training data). Simultaneously, it collects data online, performs data annotation, and continuously trains the model (which may correspond to the online updating of the application algorithm model in the target application according to the second online training data and the incentive feedback function), including:
calling the create_model( ) function through “procedure.py” to create a neural network model for network fault detection online;
calling the getAPI( ) function and getDataForAlgorithm( ) function through “procedure.py” to obtain the online training data required by the algorithm from the data retrieval interface, and input it into the docker for running the algorithm model;
calling the DataAnnotation( ) function through “procedure.py” to annotate the online collected data and generate a training dataset;
calling the trainRLAlgorithm( ) function through “procedure.py” to train the neural network algorithm created online using the training dataset.

(3) The application online module (i.e., application startup module) configures the application execution environment according to the received interface configuration template information (corresponding to the above interface configuration) and application procedure template information (corresponding to the above process configuration), configures the application operation environment, and creates and trains the algorithm model through the model training platform (service), specifically including the following:
calling the getAPI( ) function and getDataForAlgorithm( ) function through “procedure.py” to obtain the raw data required by the algorithm from the data retrieval interface, and input it into the docker for running the algorithm model;
calling the loadRLAlgorithm( ) function through “procedure.py” to obtain the trained algorithm model;
calling the runRLAlgorithm( ) function through “procedure.py” to input the required data into the algorithm model. The algorithm model performs analysis and inference on the input data to obtain the network fault analysis and location result;
notifying the intelligent application consumer (operation and maintenance personnel management interface or network management system) of the network fault analysis and location result.

The accuracy feedback function is called to assess an inference prediction result of an AI model and provide a feedback reward value based on the assessment. When the feedback reward value is a negative, indicating that the current AI model has a significant error, the steps in operations (2) and (3) of this procedure can be repeated to retrain the model. This corresponds to the application algorithm information, which includes an incentive feedback function; after deploying and releasing the target application according to the application resource, the operation environment and the application algorithm model, it further includes: online updating the application algorithm model in the target application according to second online training data and the incentive feedback function.

Based on the above, this solution proposes a general method for designing, orchestrating, and deploying a network intelligent application. The user only needs to generate an intelligent application file compression package according to a template, load it to the application operation platform through an intelligent management and control platform, automatically complete resource exploration, service configuration, network configuration, and perform online training of the algorithm model as needed, thereby realizing automatic deployment and flexible operation of a network intelligent application. Specifically, this involves the following.

(1) This solution provides a general design template for releasing a network intelligent application, including four sub-templates: an algorithm environment sub-template, an interface configuration sub-template, an algorithm model sub-template and an intelligent application procedure sub-template. The intelligent application procedure sub-template is highly flexible, functionalizing a process and supporting flexible calling and arrangement. It contains all the information that the user-customized network intelligent application can be automatically deployed and released and operated on an intelligent platform. The user can generate corresponding files for each template format according to an intelligent application requirement, and package them into an intelligent application file compression package.

(2) The intelligent application file compression package is used to package parameter information such as environment, interface, algorithm model, and intelligent application process, etc. The compressed package is parsed in a corresponding management and control module to achieve flexible configuration and deployment.

(3) It adapts and is compatible with a network scenario. Through the application management and control platform and the application operation platform, it enables real-time data acquisition and distribution while interfacing with the network management system to achieve network data collection and network control (i.e., obtain data from the network management system and feedback the analysis result).

(1) In this solution, when deploying the intelligent application algorithm model, it is only necessary to generate the intelligent application file according to the corresponding template provided by this solution to realize the unified deployment of the algorithm model. There is no need to convert to a unified format, which improves deployment efficiency and reduces management complexity. Additionally, after the model is deployed, the solution further provides configurations for data collection, inference execution pathways with the managed network environment, and mechanisms for online continuous learning and iterative optimization.

(2) In this solution, the resource exploration module is used to interact with the application operation platform and the application network environment to separately check and confirm the environment requirement (whether the operation environment resource requirement and algorithm model operation environment condition are met) and configuration requirement (whether the data interface and management and control capability condition are met) of the intelligent application. This enhances the flexibility of automatic deployment of intelligent application.

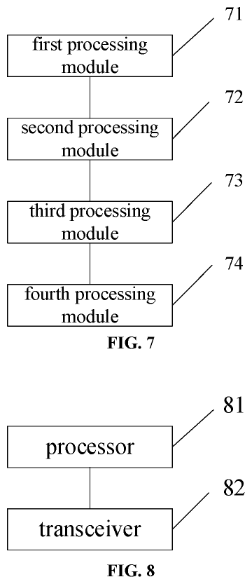

The embodiments of the present application further provide a data processing apparatus, as shown in FIG. 7, including:
a first processing module 71, configured to obtain application requirement information according to function requirement information and preset template information;
a second processing module 72, configured to perform resource exploration according to the application requirement information;
a third processing module 73, configured to, when a result of the resource exploration indicates that a target application is allowed to operate, according to the application requirement information, allocate, from target operation platform resource, application resource to the target application, and create an operation environment for the target application;
a fourth processing module 74, configured to deploy and release the target application according to the application resource and the operation environment;
wherein the target application is an application program corresponding to the application requirement information.

The data processing apparatus provided by the embodiments of the present application obtains application requirement information according to function requirement information and preset template information; performs resource exploration according to the application requirement information; and deploys and releases the target application when the result of the resource exploration indicates that the target application is allowed to operate; wherein the target application is the application program corresponding to the application requirement information. Accordingly, it may achieve the goal of automatically deploying and releasing an application according to the requirement, improve processing efficiency and accuracy, reduce manual operations, and reduce labor costs. It effectively solves the problems of high labor cost, low efficiency, and low accuracy of information processing solutions for the application deployment and release in related art.

The preset template information includes at least one of the followings: environment requirement information; interface configuration information; application algorithm information; or application procedure information.

In the embodiments of the present disclosure, the performing the resource exploration according to the application requirement information includes: exploring whether target release environment resource and/or the target operating platform resource meet deployment and release requirements of the target application according to the application requirement information.

The deploying and releasing the target application further includes: obtaining a trained application algorithm model according to the application algorithm information in the application requirement information; or, obtaining offline training data according to the application algorithm information in the application requirement information; obtaining an application algorithm model through online training according to the offline training data; or, obtaining first online training data according to the application algorithm information in the application requirement information; obtaining an application algorithm model through online training according to the first online training data; the deploying and releasing the target application according to the application resource and operation environment includes: deploying and releasing the target application according to the application resource, operation environment and application algorithm model.

In the embodiments of the present disclosure, the application algorithm information includes: data annotation script information; the obtaining the first online training data according to the application algorithm information in the application requirement information includes: online collecting data annotation of data according to the data annotation script information, and generating the first online training data.

The application algorithm information includes an incentive feedback function; the data processing apparatus further includes: a first update module, configured to online update the application algorithm model in the target application online according to second online training data and the incentive feedback function after deploying and releasing the target application according to the application resource, the operation environment and the application algorithm model.

Furthermore, the data processing apparatus further includes: a fifth processing module, configured to use the target application to obtain input data and analyze the input data to obtain an application analysis result after deploying and releasing the target application.

In the embodiments of the present disclosure, the obtaining input data by using the target application includes: obtaining offline input data by using the target application, or obtaining online input data from a network management system; the data processing apparatus further includes: a first sending module, configured to send the application analysis result to the network management system after obtaining the application analysis result.

The implementations of the embodiments of the data processing method are all applicable to the implementations of the embodiments of the data processing apparatus and can achieve the same technical effects.

The embodiments of the present application further provide a data processing device, as shown in FIG. 8, including: a processor 81;
the processor 81 is configured to: obtain application requirement information according to function requirement information and preset template information;
perform resource exploration according to the application requirement information;
when a result of the resource exploration indicates that a target application is allowed to operate, according to the application requirement information, allocate, from the target operation platform resource, application resource to the target application, and create an operation environment for the target application;
deploy and release the target application according to the application resource and operation environment;
wherein the target application is an application program corresponding to the application requirement information.

In the embodiments of the present disclosure, the data processing device may further include: a transceiver 82 capable of communicating with the processor 81, but the present disclosure is not limited thereto.

The data processing device provided by the embodiments of the present application obtains application requirement information according to function requirement information and preset template information; performs resource exploration according to the application requirement information; and deploys and releases the target application when the result of the resource exploration indicates that the target application is allowed to operate; wherein the target application is the application corresponding to the application requirement information. This may achieve the goal of automatically deploying and releasing an application according to the requirement, improve processing efficiency and accuracy, reduce manual operations, and reduce labor costs. It effectively solves the problems of high labor cost, low efficiency, and low accuracy of information processing solutions for the application deployment and release in related art.

The preset template information includes at least one of the followings: environment requirement information; interface configuration information; application algorithm information; or application procedure information.

In the embodiments of the present disclosure, the performing the resource exploration according to the application requirement information includes: exploring whether target release environment resource and/or the target operating platform resource meet deployment and release requirements of the target application according to the application requirement information.

The deploying and releasing the target application further includes: obtaining a trained application algorithm model according to application algorithm information in the application requirement information; or obtaining offline training data according to the application algorithm information in the application requirement information; and performing online training according to the offline training data, to obtain the application algorithm model; or obtaining first online training data according to the application algorithm information in the application requirement information; and performing online training according to the first online training data to obtain the application algorithm model; the deploying and releasing the target application according to the application resource and operation environment includes: deploying and releasing the target application according to the application resource, the operation environment and the application algorithm model.

In the embodiments of the present disclosure, the application algorithm information includes: data annotation script information; the obtaining the first online training data according to the application algorithm information in the application requirement information includes: online collecting data annotation of data according to the data annotation script information, and generating the first online training data.

The application algorithm information includes an incentive feedback function; the processor is further configured to, after deploying and releasing the target application according to the application resource, operation environment and application algorithm model, online update the application algorithm model in the target application online according to second online training data and the incentive feedback function.

Furthermore, the processor is further configured to, after deploying and releasing the target application, obtain input data by using the target application, and analyze the input data to obtain an application analysis result.

In the embodiments of the present disclosure, the obtaining the input data by using of the target application includes: obtaining offline input data by using the target application, or obtaining online input data from a network management system via a transceiver; the processor is further configured to, after obtaining the application analysis result, send the application analysis result to the network management system via a transceiver.

The implementations of the embodiments of the data processing method are all applicable to the implementations of the embodiments of the data processing device and can achieve the same technical effects.

The embodiments of the present application further provide a data processing device, including a memory, a processor, and a program stored in the memory and executable on the processor; wherein the processor is configured to execute the program to implement the data processing method.

The implementations of the embodiments of the data processing method are all applicable to the implementations of the embodiments of the data processing device and can achieve the same technical effects.

The embodiments of the present application further provide a readable storage medium storing a program, wherein the program is used to be executed by a processor to implement the steps of the data processing method.

The implementations of the embodiments of the data processing method are all applicable to the implementations of the embodiments of the readable storage medium and can achieve the same technical effects.

It should be noted that many functional components described in this specification are referred to as modules in order to more particularly emphasize independence of the implementation.

In the embodiments of the present disclosure, the module may be implemented in software so that it may be executed by various types of processors. For example, an identified executable code module may include one or more physical or logical blocks of computer instructions, which may be constructed as an object, a process or a function. Nevertheless, the executable code of the identified module does not need to be physically located together, but may include different instructions stored in different locations, which, when logically combined, constitute the module and achieve the specified purpose of the module.

In practice, an executable code module may be of a single instruction or multiple instructions, and may even be distributed across multiple different code segments, across different programs, and across various storage devices. Similarly, operational data may be identified within the module and may be implemented in any suitable form, organized within any appropriate type of data structure. The operational data may be collected as a single dataset, or may be distributed across different locations (including on different storage devices), and may at least partially exist merely as an electronic signal on a system or network.

When a module is implemented in software, considering the current level of hardware technology, a corresponding hardware circuit may also be constructed by those skilled in the art to achieve the same functionality, without considering the cost. The hardware circuit includes a conventional Very Large Scale Integration Circuit (VLSI) circuit or gate array and existing semiconductors such as logic chips, transistors, or other discrete components. The module may also be implemented using a programmable hardware device, such as a field programmable gate array, a programmable array logic, a programmable logic device, etc.

The above are preferred embodiments of the present disclosure. It should be noted that various modifications and refinements may be made by those of ordinary skill in the art without departing from the principles of the present disclosure. These modifications and refinements should also fall within the protection scope of the present disclosure.

1. A data processing method, comprising:
obtaining application requirement information according to function requirement information and preset template information;
performing resource exploration according to the application requirement information;
when a result of the resource exploration indicates that a target application is allowed to operate, according to the application requirement information, allocating, from target operating platform resource, application resource to the target application, and creating an operation environment for the target application;
deploying and releasing the target application according to the application resource and the operation environment;
wherein the target application is an application program corresponding to the application requirement information.

2. The data processing method according to claim 1, wherein the preset template information comprises at least one of the followings:
environment requirement information;
interface configuration information;
application algorithm information; or
application procedure information.

3. The data processing method according to claim 1, wherein the performing the resource exploration according to the application requirement information comprises:
exploring whether target release environment resource and/or the target operating platform resource meet deployment and release requirements of the target application according to the application requirement information.

4. The data processing method according to claim 1, wherein the deploying and releasing the target application further comprises:
obtaining a trained application algorithm model according to application algorithm information in the application requirement information; or
obtaining offline training data according to the application algorithm information in the application requirement information; and performing online training according to the offline training data, to obtain the application algorithm model; or
obtaining first online training data according to the application algorithm information in the application requirement information; and performing online training according to the first online training data to obtain the application algorithm model;
the deploying and releasing the target application according to the application resource and operation environment comprises:
deploying and releasing the target application according to the application resource, the operation environment and the application algorithm model.

5. The data processing method according to claim 4, wherein the application algorithm information comprises: data annotation script information;
the obtaining the first online training data according to the application algorithm information in the application requirement information comprises:
online collecting data annotation of data according to the data annotation script information, and generating the first online training data.

6. The data processing method according to claim 4, wherein the application algorithm information comprises an incentive feedback function;
after deploying and releasing the target application according to the application resource, the operation environment and the application algorithm model, the method further comprises:
online updating the application algorithm model in the target application according to second online training data and the incentive feedback function.

7. The data processing method according to claim 1, wherein after deploying and releasing the target application, the method further comprises:
obtaining input data by using the target application, and analyzing the input data to obtain an application analysis result.

8. The data processing method according to claim 7, wherein the obtaining the input data by using the target application comprises:
obtaining offline input data by using the target application, or obtaining online input data from a network management system;
after obtaining the application analysis result, the method further comprises:
sending the application analysis result to the network management system.

9-10. (canceled)

11. A data processing device, comprising a memory, a processor, and a program stored in the memory and executable on the processor; wherein the processor is configured to execute the program to implement a data processing method comprising:
obtaining application requirement information according to function requirement information and preset template information;
performing resource exploration according to the application requirement information;
when a result of the resource exploration indicates that a target application is allowed to operate, according to the application requirement information, allocating, from target operating platform resource, application resource to the target application, and creating an operation environment for the target application;
deploying and releasing the target application according to the application resource and the operation environment;
wherein the target application is an application program corresponding to the application requirement information.

12. A non-transitory readable storage medium storing therein a program, wherein the program is used to be executed by a processor to implement a data processing method comprising:
obtaining application requirement information according to function requirement information and preset template information;
performing resource exploration according to the application requirement information;
when a result of the resource exploration indicates that a target application is allowed to operate, according to the application requirement information, allocating, from target operating platform resource, application resource to the target application, and creating an operation environment for the target application;
deploying and releasing the target application according to the application resource and the operation environment;
wherein the target application is an application program corresponding to the application requirement information.

13. The data processing device according to claim 11, wherein the preset template information comprises at least one of the followings:
environment requirement information;
interface configuration information;
application algorithm information; or
application procedure information.

14. The data processing device according to claim 11, wherein the performing the resource exploration according to the application requirement information comprises:
exploring whether target release environment resource and/or the target operating platform resource meet deployment and release requirements of the target application according to the application requirement information.

15. The data processing device according to claim 11, wherein the deploying and releasing the target application further comprises:
obtaining a trained application algorithm model according to application algorithm information in the application requirement information; or
obtaining offline training data according to the application algorithm information in the application requirement information; and performing online training according to the offline training data, to obtain the application algorithm model; or
obtaining first online training data according to the application algorithm information in the application requirement information; and performing online training according to the first online training data to obtain the application algorithm model;
the deploying and releasing the target application according to the application resource and operation environment comprises:
deploying and releasing the target application according to the application resource, the operation environment and the application algorithm model.

16. The data processing device according to claim 15, wherein the application algorithm information comprises: data annotation script information;
the obtaining the first online training data according to the application algorithm information in the application requirement information comprises:
online collecting data annotation of data according to the data annotation script information, and generating the first online training data.

17. The data processing device according to claim 15, wherein the application algorithm information comprises an incentive feedback function;
after deploying and releasing the target application according to the application resource, the operation environment and the application algorithm model, the method further comprises:
online updating the application algorithm model in the target application according to second online training data and the incentive feedback function.

18. The data processing device according to claim 11, wherein the processor is further configured to execute the program to: after deploying and releasing the target application,
obtain input data by using the target application, and analyze the input data to obtain an application analysis result.

19. The data processing device according to claim 18, wherein the obtaining the input data by using the target application comprises:
obtaining offline input data by using the target application, or obtaining online input data from a network management system;
after obtaining the application analysis result, the method further comprises:
sending the application analysis result to the network management system.

20. The non-transitory readable storage medium according to claim 12, wherein the preset template information comprises at least one of the followings:
environment requirement information;
interface configuration information;
application algorithm information; or
application procedure information.

21. The non-transitory readable storage medium according to claim 12, wherein the performing the resource exploration according to the application requirement information comprises:
exploring whether target release environment resource and/or the target operating platform resource meet deployment and release requirements of the target application according to the application requirement information.

22. The non-transitory readable storage medium according to claim 12, wherein the deploying and releasing the target application further comprises:
obtaining a trained application algorithm model according to application algorithm information in the application requirement information; or
obtaining offline training data according to the application algorithm information in the application requirement information; and performing online training according to the offline training data, to obtain the application algorithm model; or
obtaining first online training data according to the application algorithm information in the application requirement information; and performing online training according to the first online training data to obtain the application algorithm model;
the deploying and releasing the target application according to the application resource and operation environment comprises:
deploying and releasing the target application according to the application resource, the operation environment and the application algorithm model.
